(19) United States
(12) Patent Application Publication
(10) Pub. No.: US 2024/0267748 A1
(43) Pub. Date: Aug. 8, 2024

(54) ACCESS POINT COORDINATION USING GRAPHS AND MACHINE LEARNING PROCESSES

(71) Applicant: Cisco Technology, Inc., San Jose, CA (US)

(72) Inventors: Doosan Jung, Lakewood, CO (US); Qixu Gong, Clyde Hill, WA (US); Qihong Shao, Santa Clara, CA (US)

(73) Assignee: Cisco Technology, Inc., San Jose, CA (US)

(21) Appl. No.: 18/166,264

(22) Filed: Feb. 8, 2023

(51) Int. Cl. H04W 16/20; H04L 41/16

(52) U.S. Cl. CPC H04W 16/20; H04L 41/16; H04W 84/12

(57) ABSTRACT

AP coordination, and more specifically intelligent AP coordination using a graph network and reinforcement learning may be provided. AP coordination may include translating a physical space into a logical space, wherein the physical space is being evaluated for AP coordination. A machine learning process may predict signal strengths of signals sent by one or more Access Points (APs) and received by one or more Stations (STAs), wherein the machine learning process uses the logical space, and wherein each STA is in a location of the physical space. One or more AP placements may be evaluated based on the signal strengths, and a recommended AP placement may be determined based on the evaluation.

### TECHNICAL FIELD

The present disclosure relates generally to providing AP coordination, and more specifically intelligent AP coordination using a graph network and reinforcement learning.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for Access Point (AP) coordination;

FIG. 2 is a block diagram of a physical space evaluated for AP coordination;

FIG. 3 is a graph of Stations (STAs) and APs;

FIG. 4A is a block diagram of a heatmap generated for a first AP;

FIG. 4B is a block diagram of a heatmap generated for a second AP;

FIG. 4C is a block diagram of a heatmap generated for multiple APs;

FIG. 5 is a graph of APs and positions of STAs;

FIG. 6 is a graph of APs, STAs, and positions of STAs;

FIG. 7 is a diagram of AP placement evaluations;

FIG. 8 is a process 800 for AP placement evaluation using reinforcement learning;

FIG. 9 is a block diagram of a method for AP coordination;

FIG. 10 is a block diagram of a method for training a machine learning process for AP coordination; and

FIG. 11 is a block diagram of a computing device.

### DETAILED DESCRIPTION

### Overview

Access Point (AP) coordination, and more specifically intelligent AP coordination using a graph network and reinforcement learning may be provided. AP coordination may include translating a physical space into a logical space, wherein the physical space is being evaluated for AP coordination. A machine learning process may predict signal strengths of signals sent by one or more APs and received by one or more Stations (STAs), wherein the machine learning process uses the logical space, and wherein each STA is in a location of the physical space. One or more AP placements may be evaluated based on the signal strengths, and a recommended AP placement may be determined based on the evaluation.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Coordinating multiple Access Points (AP) to support maximum or otherwise optimized wireless performance may be implemented when installing network devices including APs. Network environments may be unique (e.g., area of coverage, devices used, obstructions, etc.), so AP installation to support maximum wireless performance may require prior knowledge about the installation area (e.g., a floor plan with precise dimensions and/or other details), installation by trained professionals, and/or site surveys. For example, predictive and/or on-location site surveys may be performed to optimize the multi-AP coordination. Often, network providers may generate a Wi-Fi heat map to visually represent the wireless signal coverage and strength. The heatmap may be overlaid on top of a building/facility/house floor plan to help users understand. However, the heatmap may not explicitly provide locations for the multiple APs for the network optimization.

Wi-Fi signals can propagate through walls and obstacles, but the signal strength may be diminished and impact a Station's (STA) (e.g., a client device) network performance. Simulating locations may be complex and costly because the simulation may need to include wall materials, wall thickness, Wi-Fi band/channels, etc. to generate an accurate simulation that can be used for AP coordination. Both predictive and/or on-location site surveys may need to know how the space is constructed, what the obstructions are, and how the obstructions and construction impact the wireless performance.

Therefore, systems and methods for AP coordination are described herein that may not require a floor plan, location structure, number of obstacles, obstacle positions, obstacle material information, and/or the like. The systems and methods for AP coordination may not require prior knowledge of the location, may automate the placement of APs for optimal network performance, may provide alternative AP placements for high or otherwise acceptable network performance, and/or the like.

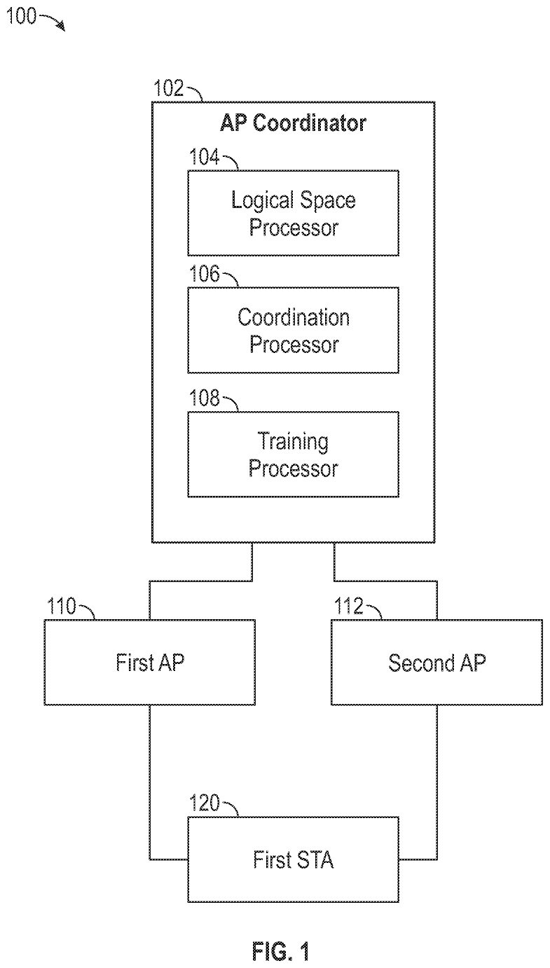

FIG. 1 is an operating environment 100 for providing AP coordination. The operating environment 100 may include an AP coordinator 102, a first AP 110, a second AP 112, and a first STA 120. The AP coordinator 102 may be any device can communicate with APs, STAs, and/or other devices of and/or connected to a network to coordinate APs (e.g., the first AP 110 and the second AP 112). The AP coordinator 102 may be a local or remote to the location the AP coordinator 102 may be coordinating AP placement for. Thus, the AP coordinator 102 may communicate with the first AP 110, the second AP 112, the first STA 120, and/or other devices via a network. The first AP 110 and the second AP 112 may allow devices such as the first STA 120 to connect to a network. The first STA 120 may be any device (e.g., smart phone, tablet, personal computer, server, etc.) that connects to the network via the first AP 110, the second AP 112, and/or the like.

The AP coordinator 102 may include a logical space processor 104, a coordination processor 106, and a training processor 108. The logical space processor 104 may translate a physical space into a logical space, including obstructions, strength of obstructions, dimensions etc. The logical space processor 104 may create the logical space using signal strengths of signals from APs (e.g., the first AP 110 and/or the second AP 112) detected by an STA (e.g., the first STA 120), because the strength of signals may reduce when passing through obstacles, over distances, and the like. The logical space processor 104 may determine if signal strength loss is due to obstacles and/or distances by determining the relative position of the first AP 110, the second AP 112, and/or the first STA 120.

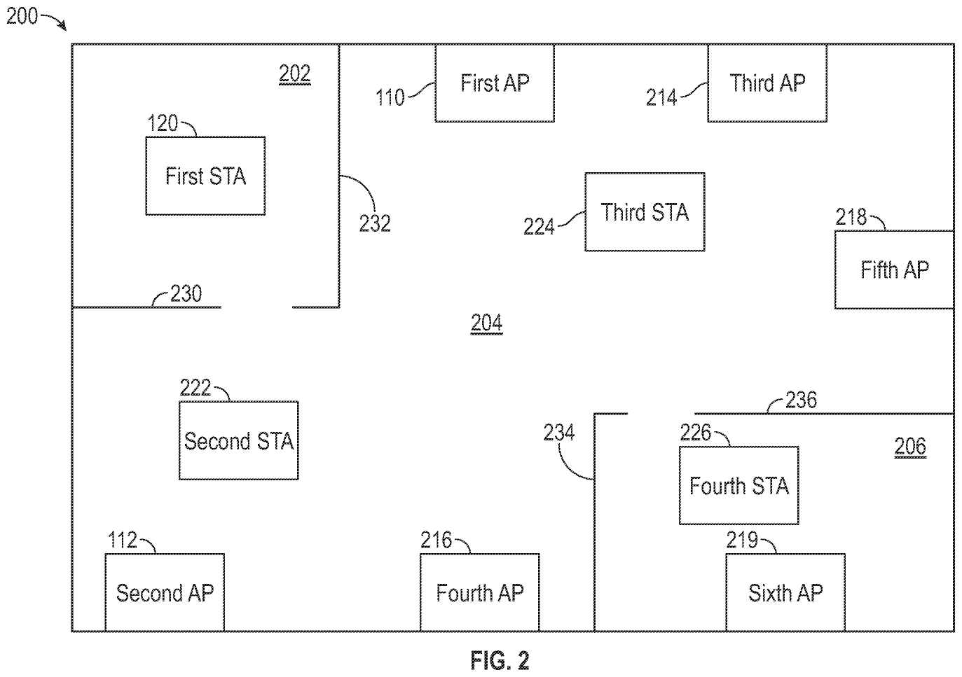

FIG. 2 is a block diagram of a physical space 200 evaluated for AP coordination. The physical space 200 may be a building with a first room 202, a second room 204, and a third room 206. The physical space 200 may include the first AP 110, the second AP 112, a third AP 214, a fourth AP 216, a fifth AP 218, a sixth AP 219, the first STA 120, a second STA 222, a third STA 224, and a fourth STA 226. The physical space 200 may include a first obstacle 230, a second obstacle 232, a third obstacle 234, and a fourth obstacle 236. The first obstacle 230, the second obstacle 232, the third obstacle 234, and the fourth obstacle 236 may be obstacles that partition the physical space 200 into the first room 202, the second room 204, and the third room 206, such as walls, windows, counters, furniture, and/or the like.

In some examples, there may be more and/or fewer APs and/or STAs. For example, there may be a single AP (e.g., the first AP 110) and a single STA (e.g., the first STA 120), and the single AP and single STA may be moved to the different positions of APs and/or STAs (e.g., the positions of the APs and/or STAs shown in FIG. 2) for the AP coordinator 102 to create a logical space of the physical space 200 and/or receive actual signals strengths of signals sent by the APs and received by the STAs. Thus, the single AP may be considered the first AP 110 in one position, the second AP 112 in another position, the third AP 214 in yet another position, and/or the like, so the AP coordinator 102 may evaluate signal strengths for multiple positions of the AP. Similarly, the single STA may be considered the first STA 120 in one position, the second STA 222 in another position, the third STA 224 in yet another position, and/or the like, so the AP coordinator 102 may evaluate signal strengths for multiple positions of the STA.

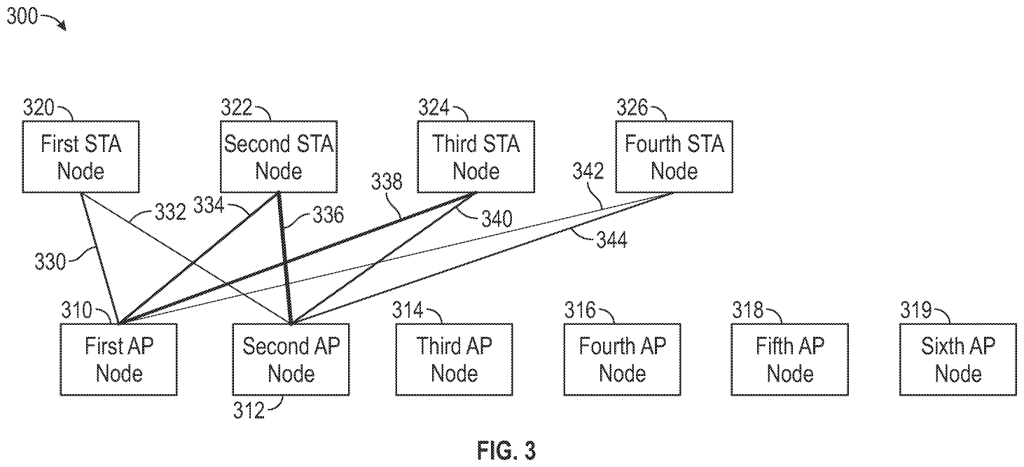

FIG. 3 illustrates a graph 300 of APs and STAs. The graph 300 may include a first AP node 310, a second AP node 312, a third AP node 314, a fourth AP node 316, a fifth AP node 318, a sixth AP node 319, a first STA node 320, a second STA node 322, a third STA node 324, and a fourth STA node 326. The graph 300 may also include a first edge 330, a second edge 332, a third edge 334, a fourth edge 336, a fifth edge 338, a sixth edge 340, a seventh edge 342, and an eighth edge 344. The AP coordinator 102, via the logical space processor 104 for example, may generate the graph 300 based on the signal strength of connections between APs and STAs.

The AP coordinator 102, via the logical space processor 104 for example, may encode the first AP 110, the second AP 112, the third AP 214, the fourth AP 216, the fifth AP 218, and/or the sixth AP 219 as a first type of node (e.g., an AP node). Thus, the logical space processor 104 may encode the first AP 110, the second AP 112, the third AP 214, the fourth AP 216, the fifth AP 218, and the sixth AP 219 as the first AP node 310, the second AP node 312, the third AP node 314, the fourth AP node 316, the fifth AP node 318, and the sixth AP node 319 respectively. The AP coordinator 102, via the logical space processor 104 for example, may encode the first STA 120, the second STA 222, the third STA 224, and/or the fourth STA 226 as a second type of node (e.g., an STA node). Thus, the logical space processor 104 may encode the first STA 120, the second STA 222, the third STA 224, and the fourth STA 226 as the first STA node 320, the second STA node 322, the third STA node 324, and the fourth STA node 326 respectively. In some examples, the nodes may be created using fewer APs and/or STAs such as one AP and/or one STA, and the AP and/or STA may be positioned in different locations for each node. For example, an STA may be a mobile device such as a smart phone, and the smart phone may be moved to different positions and receive signals at the different positions.

The logical space processor 104 may create edges (e.g., the first edge 330, the second edge 332, the third edge 334, the fourth edge 336, the fifth edge 338, the sixth edge 340, the seventh edge 342, and the eighth edge 344) between the AP nodes and the STA nodes, and the edges may indicate a connection (e.g., the signal strength between an AP and an STA) between the respective AP node and STA node. In this example, there are no connections to the third AP 214, the fourth AP 216, the fifth AP 218, and the sixth AP 219, so there are no edges to the third AP node 314, the fourth AP node 316, the fifth AP node 318, and the sixth AP node 319. The lack of connections may indicate that one or more of the APs is not operating for the AP coordination and/or that none of the STAs can communicate with one or more of the APs. Thus, the first AP 110 and the second AP 112 are the two APs used for AP coordination in this example. More or fewer APs may be used for AP coordination in further examples.

The first STA 120 may connect to the first AP 110 and the second AP 112, so the logical space processor 104 may create the first edge 330 and the second edge 332 to indicate the connections by connecting the first STA node 320 to the first AP node 310 and the second AP node 312 respectively. The first edge 330 may indicate the connection to the first AP 110, and the second edge 332 may indicate the connection to the second AP node 312. The second STA 222 may also connect to the first AP 110 as indicated by the third edge 334 connecting the second STA node 322 and the first AP node 310, and the second STA 222 may also connect to the second AP 112 as indicated by the fourth edge 336 connecting the second STA node 322 and the second AP node 312. The third STA 224 may also connect to the first AP 110 as indicated by the fifth edge 338 connecting the third STA node 324 and the first AP node 310, and the third STA 224 may also connect to the second AP 112 as indicated by the sixth edge 340 connecting the third STA node 324 and the second AP node 312. The fourth STA 226 may also connect to the first AP 110 as indicated by the seventh edge 342 connecting the fourth STA node 326 and the first AP node 310, and the fourth STA 226 may also connect to the second AP 112 as indicated by the eighth edge 344 connecting the fourth STA node 326 and the second AP node 312.

The logical space processor 104 may assign or otherwise determine the edges (e.g., the first edge 330, the second edge 332, the third edge 334, the fourth edge 336, the fifth edge 338, the sixth edge 340, the seventh edge 342, and the eighth edge 344) values that that indicate the signal strength of the connection between the STAs and the APs. The values may be indicated by or otherwise correspond to the thickness of the lines in the graph 300. For example, the first edge 330 and the second edge 332 may both have a value of two, indicating a signal strength that may be affected by an obstacle (e.g., the first obstacle 230 and the second obstacle 232). The third edge 334 may have a value of 8, and the fourth edge 336 may have a value of 9, indicating that the second STA 222 does not have obstacles interfering with the signals. The fourth edge 336 may have a higher value than the third edge 334 because the second STA 222 is closer to the second AP 112 than the first AP 110, as shown in FIG. 2 for example, resulting in a higher signal strength between the second STA 222 and the second AP 112 compared to the first AP 110.

Thus, the AP coordinator 102 may not know the dimensions of the physical space 200, what obstacles are in the physical space 200, the type of obstacles, and/or the like. However, the AP coordinator 102 may use the graph 300 to create a logical space which may directly (e.g., determined by the logical space processor 104) and/or indirectly (e.g., inferred by the logical space processor 104) include the dimensions of the physical space 200, what obstacles are in the physical space 200, the type of obstacles, and/or the like.

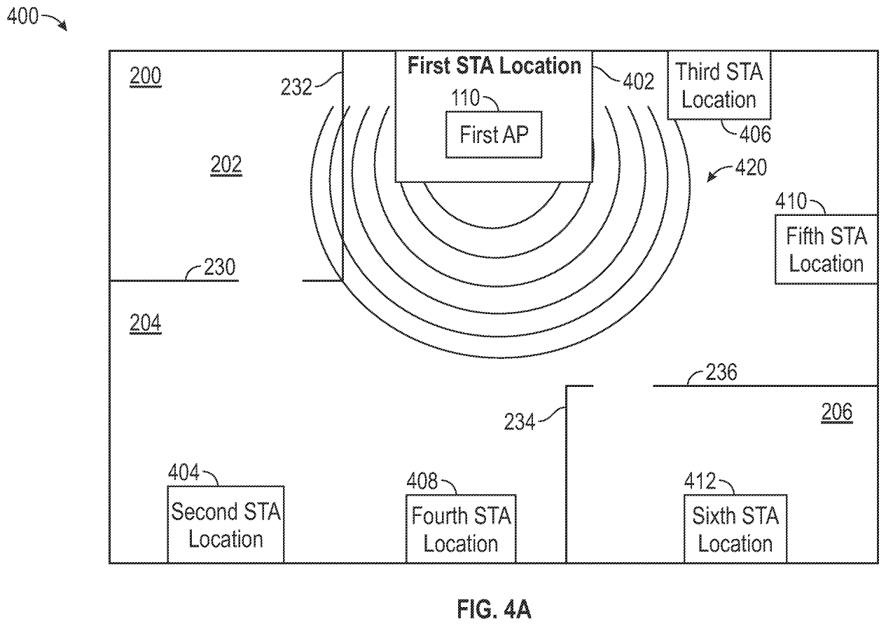

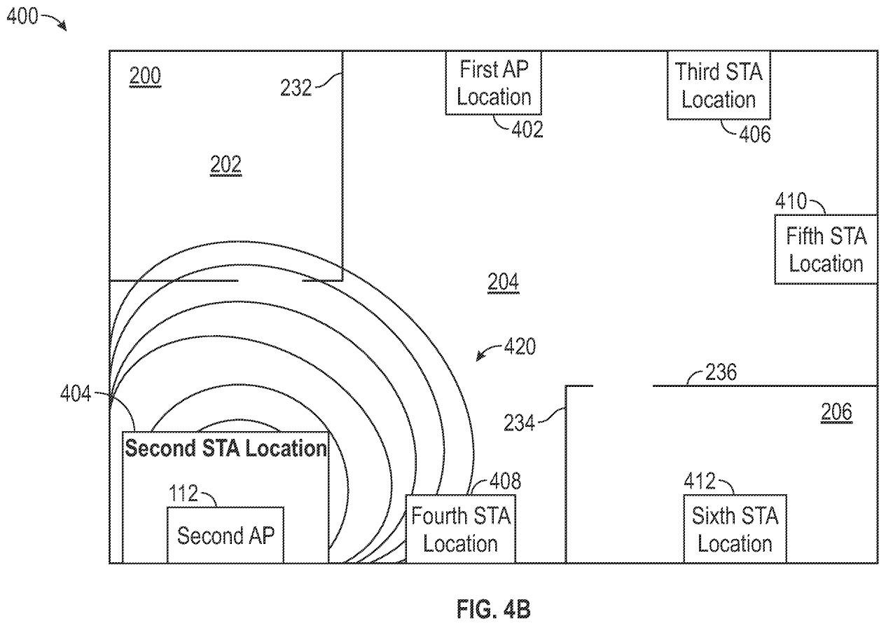

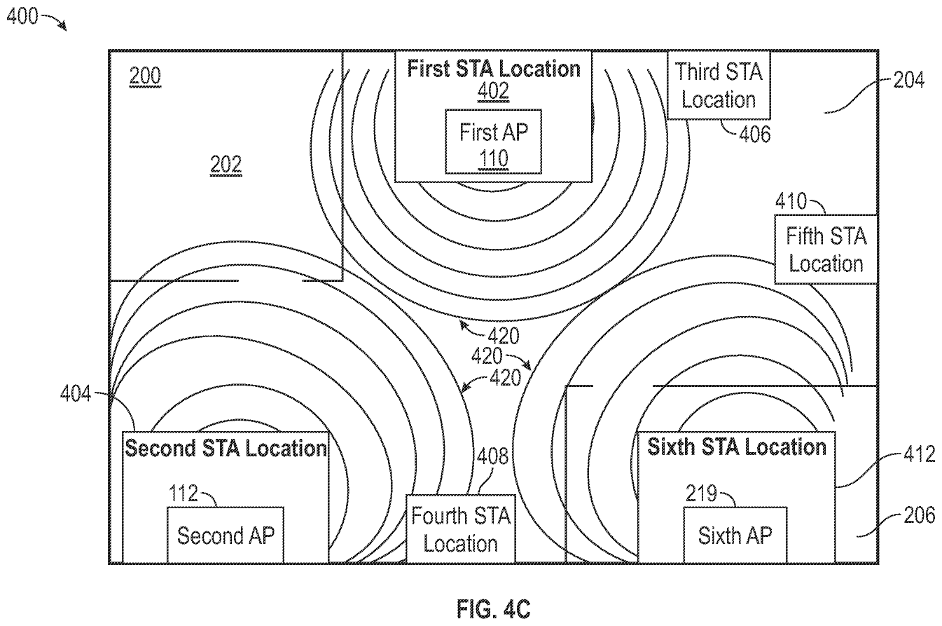

The AP coordinator 102 may also create the logical space by creating multiple heatmaps and/or some other graph with signal strengths of APs at different positions. FIG. 4A is a block diagram 400 of a heatmap generated for the first AP 110. The block diagram 400 may include the physical space 200, the first AP 110, a first STA location 402, a second STA location 404, a third STA location 406, a fourth STA location 408, a fifth STA location 410, and a sixth STA location 412. The first STA location 402, the second STA location 404, the third STA location 406, the fourth STA location 408, the fifth STA location 410, and the sixth STA location 412 may be positions for an STA (e.g., the first STA 120) to be located for creating the heatmap. For example, the first AP 110 may generate signals 420, and the first STA 120 may receive the signals at the first STA location 402, the second STA location 404, the third STA location 406, the fourth STA location 408, the fifth STA location 410, and the sixth STA location 412.

The AP coordinator 102 may receive the signals and determine the signal strength, and AP coordinator 102 may assign the STA locations a value from zero to ten where zero indicates no signal and a ten indicates the strongest signal possible. For example, at the first STA location 402, the STA may be next to the first AP 110 and receive the strongest signal possible since there are no obstructions and a small distance. Thus, the AP coordinator 102 may assign the first STA location 402 a signal strength of ten. The following table may illustrate example signal strengths determined by the AP coordinator 102 for the heatmap using the first AP 110:

| | First | Second | Third | Fourth | Fifth | Sixth |
|---|---|---|---|---|---|---|
| | STA | STA | STA | STA | STA | STA |
| | Location | Location | Location | Location | Location | Location |
| | 402 | 404 | 406 | 408 | 410 | 412 |
| First AP 110 | 10 | 5 | 9 | 7 | 8 | 3 |

FIG. 4B is the block diagram 400 of a heatmap generated for the second AP 112. The heatmap for the second AP 112 may be generated based on the signal strengths of the signals an STA receives at the first STA location 402, the second STA location 404, the third STA location 406, the fourth STA location 408, the fifth STA location 410, and/or the sixth STA location 412. The AP coordinator 102 may update the table for the heatmap using the second AP 112 as shown below:

| | First | Second | Third | Fourth | Fifth | Sixth |
|---|---|---|---|---|---|---|
| | STA | STA | STA | STA | STA | STA |
| | Location | Location | Location | Location | Location | Location |
| | 402 | 404 | 406 | 408 | 410 | 412 |
| First AP 110 | 10 | 5 | 9 | 5 | 8 | 3 |
| Second AP 112 | 6 | 10 | 4 | 8 | 5 | 2 |

Thus, the AP coordinator 102 may determine and store the signal strengths for an STA at different positions of the physical space 200 for multiple positions of the AP (e.g., the first AP 110 and the second AP 112). The table may be used as a N by K matrix, where N is the APs at different positions and K is the number of STA locations, and input into a machine learning process for coordinating APs as will be discussed in further detail herein. The AP coordinator 102 may determine heatmaps with more or fewer positions of the STA and/or with more or fewer positions of the AP. For example, another STA location may be included in the first room 202.

FIG. 4C is the block diagram 400 of a heatmap generated for multiple APs, the first AP 110, the second AP 112, and the sixth AP 219. In some examples, multiple APs may send signals to an STA to generate multiple signal strength values for the heatmap simultaneously. For example, the first AP 110, the second AP 112, and the sixth AP 219 all send signals 420 for different positions of an STA. Thus, the AP coordinator 102 may determine signal strengths for different positions of the STA for the first AP 110, the second AP 112, and the sixth AP 219 simultaneously.

Not every position of the APs and/or STAs may be measured when creating the heatmaps. Therefore, the AP coordinator 102 may use a machine learning process, such as a deep neural network, to predict the signal strengths for different positions of APs and/or STAs that may not be measured. The training processor 108 may train the machine learning process to predict the signal strengths using previously created heatmaps. Next, a reinforcement learning agent may be used to learn the policies that may result in optimal multiple AP placement for improving or otherwise optimizing the network connectivity provided by the APs. As discussed above, the heatmaps may be used to create a logical space of a physical space. For example, the resulting table that includes the signal strengths between the APs (e.g., different positions of APs and/or different APs) and the STAs (e.g., different positions of STAs and/or different STAs) may be used to create a graph such as the graph 300.

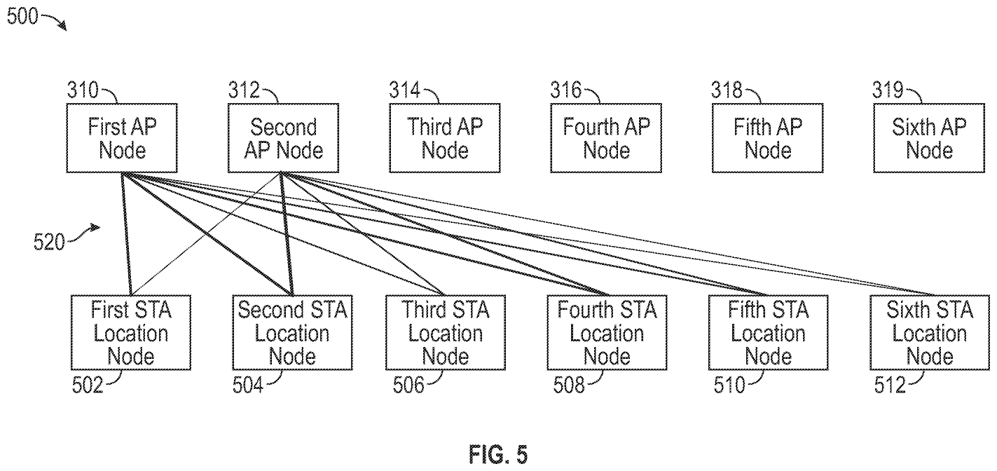

The AP coordinator 102 may create a graph to indicate the signal strengths at the positions similar to the graph 300 created to indicate the signal strengths between multiple APs and multiple STAs. FIG. 5 is a graph 500 of APs positions of STAs. The graph 500 may include

As discussed above, the AP coordinator 102 may use a machine learning process (e.g., a deep neural network) to determine the placement of APs. The machine learning process may be trained before the AP coordinator 102 is used for AP coordination and/or while the AP coordinator 102 is performing coordination. The AP coordinator 102 may also update by undergoing additional training periodically.

The training processor 108 may train the machine learning process. The training processor 108 may receive a heatmap generated by the machine learning process, such as the heatmap created as described above with respect to FIG. 4A, FIG. 4B, and FIG. 4C. The heatmap may include measured values and/or predicted values from the machine learning process. The training processor 108 may also receive measured signal strengths from multiple STAs and/or APs to compare the measured signal strengths to the measured and/or predicated values from the machine learning process. For example, referring back to FIG. 2, the AP coordinator 102 may receive measured signal strengths from the first STA 120, the second STA 222, the third STA 224, and/or the fourth STA 226 received from one or more of the APs (e.g., the first AP 110, the second AP 112, the third AP 214, the fourth AP 216, the fifth AP 218, and/or the sixth AP 219).

FIG. 5 is a graph 500 of APs and positions of STAs. For example, the graph 500 may be based on the heatmap the AP coordinator 102 determines. The AP coordinator 102 may create nodes for the STA locations (e.g., the first STA location 402, the second STA location 404, the third STA location 406, the fourth STA location 408, the fifth STA location 410, and/or the sixth STA location 412), including a first STA location node 502, a second STA location node 504, a third STA location node 506, a fourth STA location node 508, a fifth STA location node 510, and a sixth STA location node 512. The AP coordinator 102 may also determine edges 520 that indicate the signal strength of the STA at the associated location for a particular AP measured when creating the heatmap. In this example, the first AP 110 and the second AP 112 are used, but more or fewer APs may be used in additional examples.

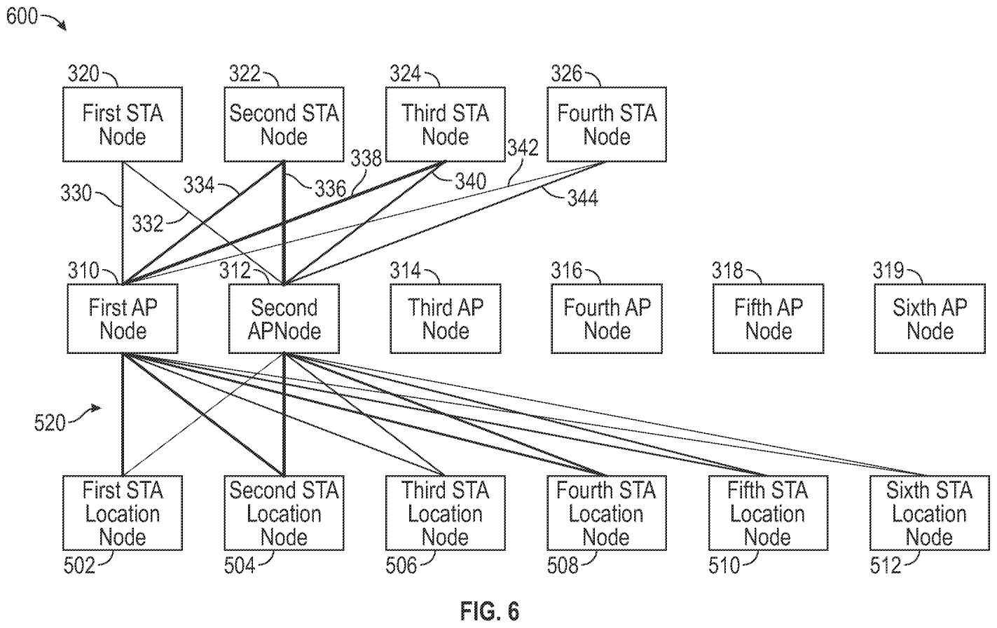

FIG. 6 is a graph 600 of APs, STAs, and positions of STAs. For example, the graph 600 may include the graph 300 and the graph 500, including the first AP node 310, the second AP node 312, the third AP node 314, the fourth AP node 316, the fifth AP node 318, the sixth AP node 319, the first STA node 320, the second STA node 322, the third STA node 324, the fourth STA node 326, the first edge 330, the second edge 332, the third edge 334, the fourth edge 336, the fifth edge 338, the sixth edge 340, the seventh edge 342, the eighth edge 344, the first STA location node 502, the second STA location node 504, the third STA location node 506, the fourth STA location node 508, the fifth STA location node 510, the sixth STA location node 512, and the edges 520. The logical space processor 104 may use the graph 600 and/or the information included in the graph 600 to determine a logical space. The coordination processor 106 may use the graph 600 and/or the information included in the graph 600 to perform AP coordination. The training processor 108 may use the graph 600 and/or the information included in the graph 600 to train the machine learning process. For example, the machine learning process may use the heatmap (e.g., the table including signal strengths for APs communicating with an STA at different locations, input as a N by K matrix for example) and the active APs to generate predicted signal strengths for a STA from each AP. The training processor 108 may receive the actual signal strengths of the STA, using the first STA 120, the second STA 222, the third STA 224, and/or the fourth STA 226 as shown in FIG. 2. The training processor 108 may then cause the machine learning process to compare the predicted signal strengths to the actual signal strengths to determine whether error is present in the predicted signal strengths. The machine learning process may alter the determination of the predicted signal strengths based on the comparison between predicted and actual signal strengths. The training processor 108 may train the machine learning process using a Stochastic Gradient Descending (SGD) method in some examples.

The training processor 108 may determine when the machine learning process has reached an accuracy level for coordinating APs (e.g., accurately predicting signal strength of APs for an STA at any location of a physical space). Once, the machine learning process has reached the accuracy level, the AP coordinator 102, via the coordination processor 106 for example, may deploy a virtual agent and train the agent using reinforcement learning so the agent can learn to recommend AP placement for optimal network performance. The agent may consider different combinations of AP placements and react to rewards, absence of rewards, and/or punishments received from the reinforcement learning to determine whether different AP placements will support strong network performance or not. The agent may determine an optimal AP placement and/or alternative AP placements that may be nearly or equally as optimal as the optimal AP placement. The agent may be rewarded for determining an optimal AP placement that includes the lowest number of APs used for the best network performance. Thus, the agent may determine that an AP placement with fewer APs and slightly below optimal network performance may be the optimal AP placement compared to an AP placement with more APS and optimal network performance. The agent may determine the optimal network performance is preferred over the difference in the number of APs in other examples, and the agent may therefore determine an AP placement with more APs compared and slightly higher network performance compared to another AP placement is the optimal AP placement.

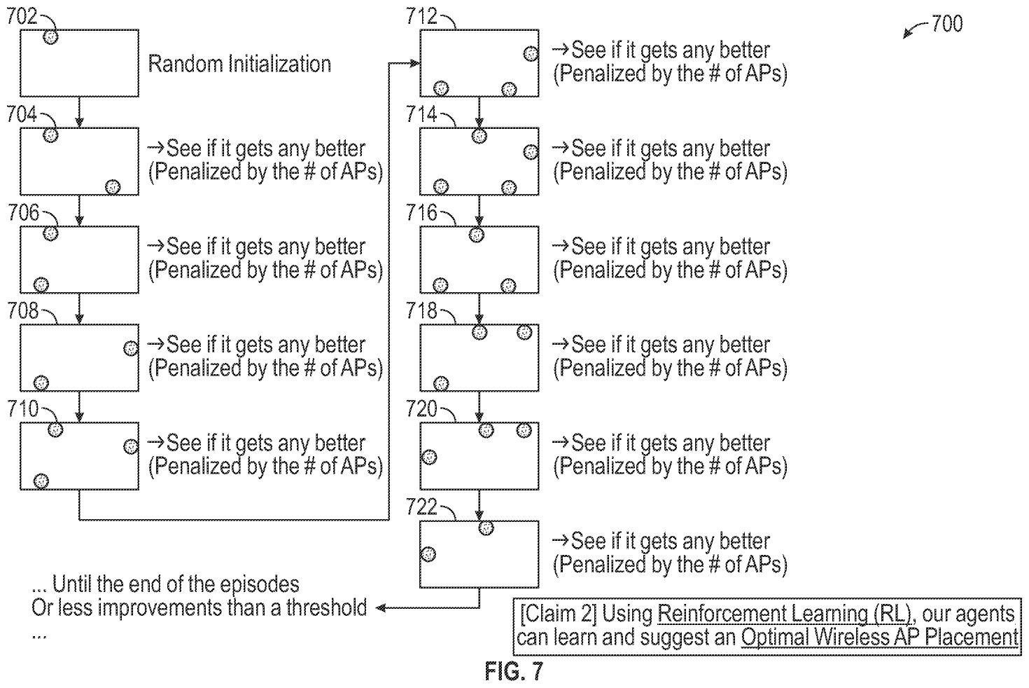

FIG. 7 is a diagram 700 of AP placement evaluations. The AP placement evaluations may include various AP placements, including differing numbers of APs and/or differing locations of the APs. The diagram 700 may include a first evaluation 702, a second evaluation 704, a third evaluation 706, a fourth evaluation 708, a fifth evaluation 710, a sixth evaluation 712, a seventh evaluation 714, an eighth evaluation 716, a ninth evaluation 718, a tenth evaluation 720, and an eleventh evaluation 722. The AP coordinator 102, via the agent for example, may perform the AP placement evaluations using reinforcement learning.

For example, the coordination processor 106 may perform an initial evaluation randomly or receive an initial evaluation. The first evaluation 702 may be the initial evaluation. The AP coordinator 102 may then perform the second evaluation 704 and determine if the AP placement in the second evaluation 704 is better than the first evaluation 702. The AP coordinator 102 may be penalized (e.g., no reward given, lower reward given, or a penalty given) for increasing the number of APs from one to two in the second evaluation 704, but the penalty may be offset by a higher reward for an improvement in network performance. The AP coordinator 102 may similarly perform the evaluation as the AP coordinator 102 proceeds to further evaluations. For example, the AP coordinator 102 may determine that including four APs is not worth the improvement in network performance in the seventh evaluation 714 and move back to three APs in the eighth evaluation 716. The AP coordinator 102 may determine an optimal placement of three APs in the tenth evaluation 720 and move to two APs in the eleventh evaluation 722 to determine if two or three APs should be used. The AP coordinator 102 may continue making additional evaluations until the AP coordinator 102 determines an optimal AP placement and/or alternative AP placements. The AP coordinator 102 may determine the optimal AP placement is determined when further evaluations do not improve the network performance more than a predetermined threshold.

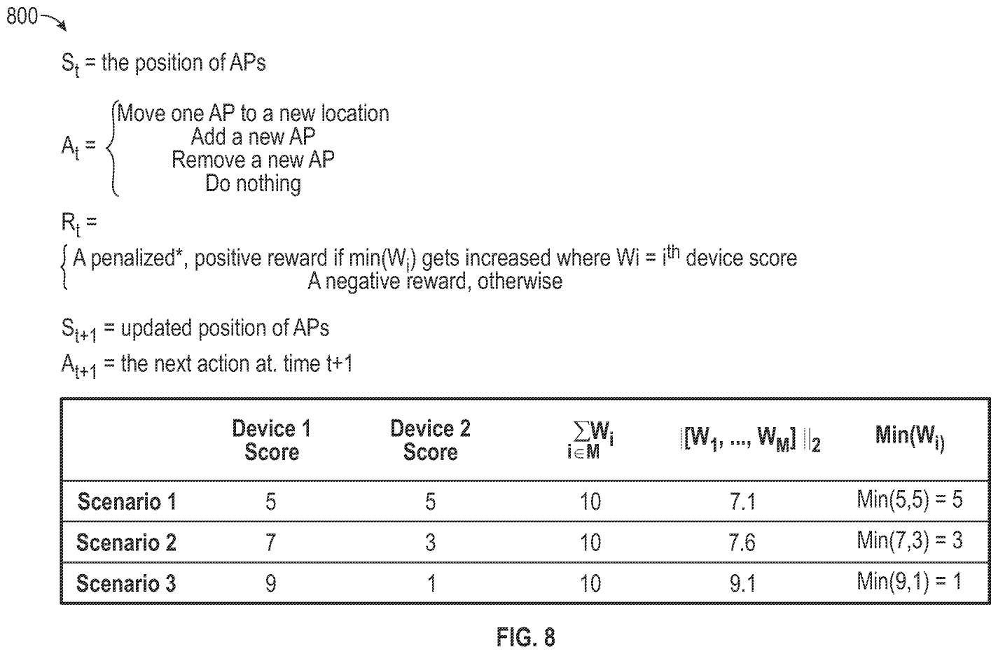

FIG. 8 is a process 800 for AP placement evaluation using reinforcement learning. The process may include Sₜ: the position of APs, Aₜ: the action for the next evaluation, and Rₜ: the reward and/or penalty of the action for the next evaluation. The action may include moving an AP to a new location, adding an AP, removing an AP, and/or doing nothing. The reward may be positive if an AP device score Wᵢ increases, indicating an increase in network performance caused by an AP. The reward may be negative if the AP placement score decreases.

The AP coordinator 102 may compute the sum of all device scores Wᵢ for an evaluation (e.g., a sum of the device score for each AP in an evaluation). The AP coordinator 102 may also determine the square root of the sum of the squared device scores (e.g., the norm) and the minimum device score for the evaluation. The AP coordinator 102 may compare each evaluation using the sum of the device scores, the square root of the sum of the squared device scores, and/or the minimum device score to determine the optimal AP placement and/or alternative AP placements. For example, the sum of the device scores may indicate the overall network performance, the norm may indicate whether certain APs are greatly contributing to network performance and may therefore be in an optimal position (e.g., the device 1 with a score of 9 in scenario 3), and the minimum device score may indicate whether an AP is not inefficient or otherwise not contributing to network performance (e.g., the device 2 with a score of 1 in scenario 3).

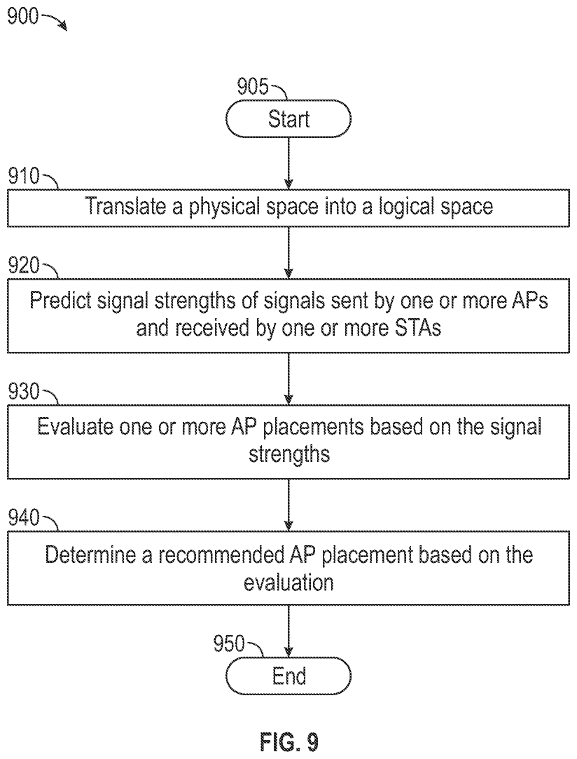

FIG. 9 is a block diagram of a method 900 for AP coordination. The method 900 may begin at starting block 905 and proceed to operation 910. In operation 910, a physical space may be translated into a logical space. For example, the AP coordinator 102 (e.g., via the logical space processor 104) may translate a physical space that is being evaluated for AP coordination to install APs into a logical space. The AP coordinator 102 may translate the physical space into the logical space by creating heatmaps for one or more AP locations. For example, an AP may transmit signals from one location (e.g., the positions of the first AP 110 shown in FIG. 3C). An STA may receive the signals in different positions (e.g., the first STA location 402, the second STA location 404, the third STA location 406, the fourth STA location 408, the fifth STA location 410, and/or the sixth STA location 412). The logical space processor 104 may create a graph (e.g., the graph 300, the graph 500, the graph 600) that represents the physical space as a logical space by including the signal strengths as edges connecting the STAs and the APs.

In operation 920, a machine learning process may predict the signal strengths of signals sent by one or more APs and received by one or more STAs. For example, the AP coordinator 102 may execute the machine learning process to use the logical space to predict signal strengths of signals transmitted by one or more APs and received by STAs in unique locations of the physical space (e.g., the locations of the first STA 120, the second STA 222, the third STA 224, and/or the fourth STA 226 shown in FIG. 2). The machine learning process may use the logical space as input (e.g., heatmaps) to predict the signal strengths received for each STA at the STA's respective location. The machine learning process may also train itself by comparing the predicted signal strengths to actual signal strengths received by STAs.

In operation 930, one or more AP placements may be evaluated based on the signal strengths. For example, the AP coordinator 102 (e.g., via the coordination processor 106) may evaluate one or more AP placements. The evaluations may include using an agent to evaluate the AP placements using reinforcement learning, including determining device scores for APs included in AP placements. The device score may indicate the contribution to network performance of the APs in the AP placements. The AP coordinator 102 may determine a sum of the device scores for the AP placements, a square root of the sum of the squared device scores for the AP placements, and/or a minimum device score for the AP placements when evaluating the AP placements.

In operation 940, a recommended AP placement may be determined based on the evaluation. For example, the AP coordinator 102 determines the recommended AP placement (e.g., an optimal AP placement) based on the evaluation of AP placements in operation 930. The AP coordinator 102 may determine the recommended AP placement using the sum of the device scores for the AP placements, the square root of the sum of the squared device scores for the AP placements, and/or the minimum device score for the AP placements when evaluating the AP placements. The AP coordinator 102 may also determine alternative recommended AP placements with different AP configurations. The method 900 may conclude at ending block 950.

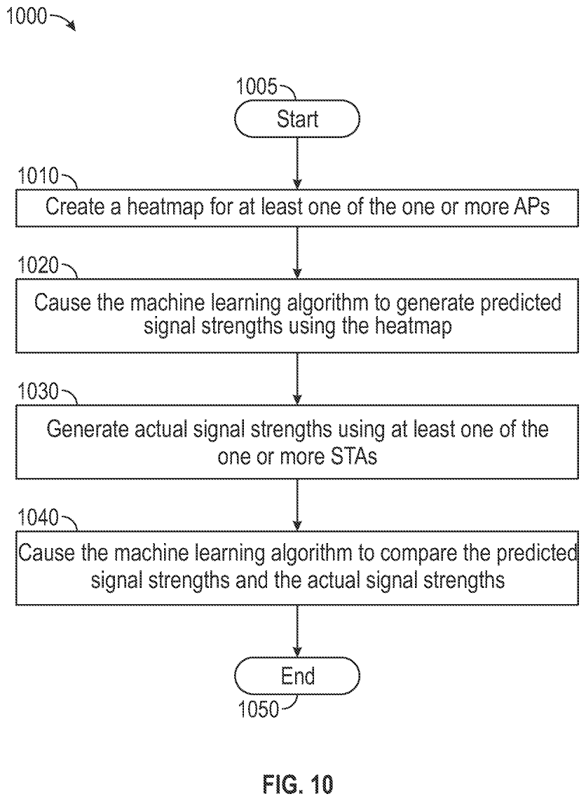

FIG. 10 is a block diagram of a method 1000 for training a machine learning process for AP coordination. The method 1000 may begin at starting block 1005 and proceed to operation 1010. In operation 1010, a heatmap for at least one of one or more APs may be created. For example, the AP coordinator 102 creates heatmaps to generate a logical space for the machine learning process to use as input.

In operation 1020, the machine learning process may generate predicted signal strengths using the heatmap. For example, the AP coordinator 102 causes the machine learning process to use the heatmap(s) as input to predict signal strengths of signals received by STAs at one or more locations.

In operation 1030, actual signal strengths may be generated using at least one of the one or more STAs. For example, the AP coordinator 102 receives signal strengths of signals received from STAs in locations of the physical space being evaluated for AP coordination.

In operation 1040, the machine learning process may compare the predicted signal strengths and the actual signal strengths. For example, the AP coordinator 102 sends the actual signal strengths to the machine learning process for the machine learning process to compare the predicted signal strengths and the actual signal strengths. The machine learning process may alter the operation of predicting the signal strengths based on the comparison. The method 1000 may conclude at ending block 1050.

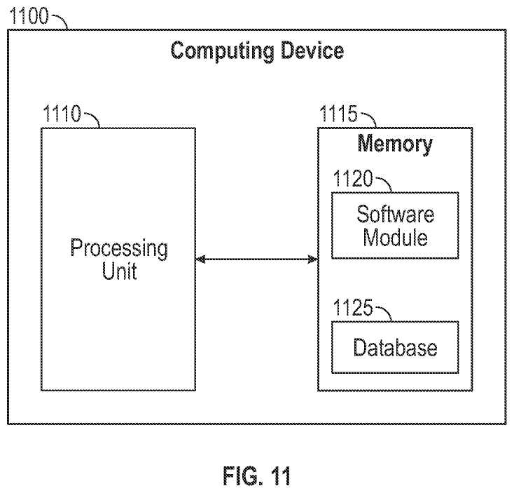

FIG. 11 is a block diagram of a computing device 1100. As shown in FIG. 11, computing device 1100 may include a processing unit 1110 and a memory unit 1115. Memory unit 1115 may include a software module 1120 and a database 1125. While executing on processing unit 1110, software module 1120 may perform, for example, processes for providing AP coordination with respect to FIG. 1, FIG. 2, FIG. 3, FIG. 4A, FIG. 4B, FIG. 4C, FIG. 5, FIG. 6, FIG. 7, FIG. 8, FIG. 9. and FIG. 10. Computing device 1100, for example, may provide an operating environment for the AP coordinator 102, the logical space processor 104, the coordination processor 106, the training processor 108, the first AP 110, the second AP 112, the first STA 120, the third AP 214, the fourth AP 216, the fifth AP 218, the sixth AP 219, the second STA 222, the third STA 224, the fourth STA 226, and/or any other system described herein. The AP coordinator 102, the logical space processor 104, the coordination processor 106, the training processor 108, the first AP 110, the second AP 112, the first STA 120, the third AP 214, the fourth AP 216, the fifth AP 218, the sixth AP 219, the second STA 222, the third STA 224, the fourth STA 226, and/or any other system described herein may operate in other environments and are not limited to computing device 1100.

Computing device 1100 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 1100 may comprise any computer operating environment, such as hand-held devices, multiprocessor systems, microprocessor-based or programmable sender electronic devices, minicomputers, mainframe computers, and the like. Computing device 1100 may also be practiced in distributed computing environments where tasks are performed by remote processing devices. The aforementioned systems and devices are examples, and computing device 1100 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 1100 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

1. A method comprising:
translating a physical space into a logical space, wherein the physical space is being evaluated for Access Point (AP) coordination;
predicting, by a machine learning process, signal strengths of signals sent by one or more APs and received by one or more Stations (STAs), wherein the machine learning process uses the logical space, and wherein each STA is in a location of the physical space;
evaluating one or more AP placements based on the signal strengths; and
determining a recommended AP placement based on the evaluation.

2. The method of claim 1, wherein translating the physical space into the logical space comprises creating a heatmap for at least one of the one or more APs.

3. The method of claim 1, further comprising training the machine learning process wherein training the machine learning process comprises:
creating a heatmap for at least one of the one or more APs;
causing the machine learning process to generate predicted signal strengths using the heatmap;
generating actual signal strengths using at least one of the one or more STAs; and
causing the machine learning process to compare the predicted signal strengths and the actual signal strengths.

4. The method of claim 1, wherein the machine learning process is a deep neural network.

5. The method of claim 1, wherein evaluating the one or more AP placements comprises:
determining device scores for APs included in the AP placements; and
determining any one of (i) a sum of the device scores for the AP placements, (ii) a square root of the sum of the squared device scores for the AP placements, (iii) a minimum device score for the AP placements, or (iv) any combination of (i)-(iii).

6. The method of claim 5, wherein determining the recommended AP placement comprises determining the recommended AP placement from the one or more AP placements based on any of (v) the sums of the device scores, (vi) the square roots of the sum of the squared device scores, (vii) the minimum device scores, or (viii) any combination of (v)-(vii).

7. The method of claim 1, further comprising determining an alternative recommended AP placement.

8. A system comprising:
a memory storage; and
a processing unit coupled to the memory storage, wherein the processing unit is operative to:
translate a physical space into a logical space, wherein the physical space is being evaluated for Access Point (AP) coordination;
predict, using a machine learning process, signal strengths of signals sent by one or more APs and received by one or more Stations (STAs), wherein the machine learning process uses the logical space, and wherein each STA is in a location of the physical space;
evaluate one or more AP placements based on the signal strengths; and
determine a recommended AP placement based on the evaluation.

9. The system of claim 8, wherein to translate the physical space into the logical space includes to create a heatmap for at least one of the one or more APs.

10. The system of claim 8, wherein the processing unit is further operative to train the machine learning process wherein the processing unit being operative to train the machine learning process comprises the processing unit being operative to:
create a heatmap for at least one of the one or more APs;
cause the machine learning process to generate predicted signal strengths using the heatmap;
generate actual signal strengths using at least one of the one or more STAs; and
cause the machine learning process to compare the predicted signal strengths and the actual signal strengths.

11. The system of claim 8, wherein the machine learning process is a deep neural network.

12. The system of claim 8, wherein the processing unit being operative to evaluate the one or more AP placements comprises the processing unit being operative to:
determine device scores for APs included in the AP placements; and
determine any one of (i) a sum of the device scores for the AP placements, (ii) a square root of the sum of the squared device scores for the AP placements, (iii) a minimum device score for the AP placements, or (iv) any combination of (i)-(iii).

13. The system of claim 12, wherein the processing unit being operative to determine the recommended AP placement comprises the processing unit being operative to determine the recommended AP placement from the one or more AP placements based on any of (v) the sums of the device scores, (vi) the square roots of the sum of the squared device scores, (vii) the minimum device scores, or (viii) any combination of (v)-(vii).

14. The system of claim 13, wherein the processing unit is further operative to determine an alternative recommended AP placement.

15. A non-transitory computer-readable medium that stores a set of instructions which when executed perform a method executed by the set of instructions comprising:
translating a physical space into a logical space, wherein the physical space is being evaluated for Access Point (AP) coordination;
predicting, by a machine learning process, signal strengths of signals sent by one or more APs and received by one or more Stations (STAs), wherein the machine learning process uses the logical space, and wherein each STA is in a location of the physical space;
evaluating one or more AP placements based on the signal strengths; and
determining a recommended AP placement based on the evaluation.

16. The non-transitory computer-readable medium of claim 15, wherein translating the physical space into the logical space comprises creating a heatmap for at least one of the one or more APs.

17. The non-transitory computer-readable medium of claim 15, further comprising training the machine learning process, wherein training the machine learning process comprises:
creating a heatmap for at least one of the one or more APs;
causing the machine learning process to generate predicted signal strengths using the heatmap;
generating actual signal strengths using at least one of the one or more STAs; and
causing the machine learning process to compare the predicted signal strengths and the actual signal strengths.

18. The non-transitory computer-readable medium of claim 15, wherein the machine learning process is a deep neural network.

19. The non-transitory computer-readable medium of claim 15, wherein evaluating the one or more AP placements comprises:
determining device scores for APs included in the AP placements; and
determining any one of (i) a sum of the device scores for the AP placements, (ii) a square root of the sum of the squared device scores for the AP placements, (iii) a minimum device score for the AP placements, or (iv) any combination of (i)-(iii).

20. The non-transitory computer-readable medium of claim 19, wherein determining the recommended AP placement comprises determining the recommended AP placement from the one or more AP placements based on any of (v) the sums of the device scores, (vi) the square roots of the sum of the squared device scores, (vii) the minimum device scores, or (viii) any combination of (v)-(vii).
